(19) United States
(12) Patent Application Publication
(10) Pub. No.: US 2010/0132464 A1
(43) Pub. Date: Jun. 3, 2010

(54) MOTION ASSISTING DEVICE

(75) Inventor: Ken Yasuhara, Wako-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/627,462

(22) Filed: Nov. 30, 2009

(30) Foreign Application Priority Data
Dec. 1, 2008 (JP) 2008-306483
Dec. 1, 2008 (JP) 2008-306484

(51) Int. Cl. G01C 19/56

(52) U.S. Cl. 73/504.12

(57) ABSTRACT

According to a motion assisting device 10 of the present invention, “second setting processing” is exceptionally performed in a situation where it is likely that the motion mode of an agent P gets out of harmony with the operation mode of the motion assisting device 10, more specifically a situation where a deviation absolute value between a first phase difference and a desired phase difference is equal to or greater than a threshold value. Besides, only a single model may be used for arithmetic processing for generating a basic oscillator as an operation control basis of an actuator 15.

### BACKGROUND OF THE INVENTION

1. Field of the Invention

The present invention relates to a device which assists an agent in making a periodic motion by applying a force to the agent.

2. Related Background Art

Conventionally, there has been suggested a device which assists a human or any other animal in making a periodic motion by applying a periodically changing force to the human or the like whose function is decreased in a body part such as a lower limb (Refer to Japanese Patent No. 4008464 and Japanese Patent No. 4008465).

Due to various factors, however, such as a rapid change in a motion mode of the agent or a delay in arithmetic processing for determining an operation mode of the device, a phase difference between a periodic motion of the agent and a periodic operation of the motion assisting device might be inappropriate in terms of maintaining the harmony between the motion mode of the agent and the operation mode of the device.

### SUMMARY OF THE INVENTION

Therefore, it is an object of the present invention to provide a device capable of assisting an agent such as a human in making motions by an operation mode appropriate in terms of maintaining the harmony with a periodic motion mode of the agent.

To this end, the present invention provides a motion assisting device, comprising: an orthosis attached to an agent; ar actuator connected to the orthosis; and a controller which controls an amplitude and a phase of an output from the actuator, the motion assisting device assisting a periodic motion of the agent by transmitting the output from the actuator to the agent via the orthosis, wherein the controller includes: a motion state measuring element adapted to measure a motion oscillator defined by a phase periodically changing according to a periodic motion of the agent; and a second oscillator generation element adapted to generate a second oscillator as a basis of the operation control of the actuator as an output oscillating signal by inputting the motion oscillator measured by the motion state measuring element as an input oscillating signal into a second model, which is defined by a simultaneous differential equation with a plurality of state variables representing motion states of the agent and generates on the basis of the input oscillating signal the output oscillating signal changing at an angular velocity determined based on a second natural angular velocity, wherein the motion state measuring element is adapted to measure a motion cycle of the agent, and wherein the controller further includes a natural angular velocity setting element adapted to set the second natural angular velocity fluidly on the basis of the motion cycle of the agent measured by the motion state measuring element.

Preferably, the controller further includes a first oscillator generation element which generates a first oscillator as the output oscillating signal by inputting a first motion oscillator, which is the motion oscillator measured by the motion state measuring element, as the input oscillating signal into a first model for generating the output oscillating signal which changes at an angular velocity determined based on a first natural angular velocity by mutually entraining the input oscillating signal; and the natural angular velocity setting element performs first setting processing in which an angular velocity of a second virtual oscillator is set as a second natural angular velocity so that a second phase difference approximates a desired phase difference according to a virtual model representing a first virtual oscillator and the second virtual oscillator which periodically change with the second phase difference while interacting with each other on the basis of a first phase difference which is a phase difference between the first motion oscillator measured by the motion state measuring element and the first oscillator generated by the first oscillator generation element, while performing second setting processing in which the second natural angular velocity is set on the basis of the motion cycle of the agent measured by the motion state measuring element with a requirement that an absolute value of a deviation between the first phase difference and the desired phase difference is equal to or greater than a threshold value, instead of the first setting processing.

According to the motion assisting device, the “first setting processing” is performed in principle to set the second natural angular velocity, and the “second setting processing” is performed exceptionally depending on the situation to set the second natural angular velocity. In other words, the second setting processing is performed in a situation where it is likely that the motion mode of the agent gets out of harmony with the operation mode of the motion assisting device, more specifically a situation where a deviation absolute value between the first phase difference and the desired phase difference is equal to or greater than the threshold value.

Since the second natural angular velocity is set based on the motion cycle of the agent by performing the second setting processing, it is possible to generate the second oscillator which oscillates at an angular velocity appropriate as the operation control basis of the motion assisting device in terms of maintaining the harmony between the motion mode of the agent and the motion assisting device. Moreover, the second setting processing requires only a shorter arithmetic processing time for setting the second natural angular velocity than the first setting processing based on the virtual model.

Therefore, in a situation where it is likely that the motion mode of the agent gets out of harmony with the operation mode of the motion assisting device as described above, it is possible to quickly set the second natural angular velocity which is appropriate in terms of maintaining the harmony. Accordingly, it is possible to assist the agent in making motions by the operation mode appropriate in terms of maintaining the harmony with the periodic motion mode of the agent.

Preferably the controller includes only the second oscillator generation element as a component having a model.

According to the motion assisting device having the above configuration, only a single model (the second model) is used for the arithmetic processing for generating the second oscillator as the control basis of the actuator. Therefore, it is possible to reduce the arithmetic processing load in comparison with the case where other models are used in addition to the single model.

Further, the natural angular velocity, which is reflected on the time rate of change of an angular velocity or a phase of the “second oscillator” which is an output oscillating signal from the model, is fluidly set on the basis of the motion cycle of the agent defined by the “motion oscillator,” which is an input oscillating signal to the model. Then, the second oscillator is generated according to the model defined by the latest natural angular velocity, and the amplitude and phase of the force transmitted from the actuator to the agent are controlled on the basis of the second oscillator. As a result, the operation cycle of the motion assisting device is able to be adjusted appropriately in terms of maintaining the harmony between the motion mode of the agent and the operation mode of the motion assisting device according to the length of the motion cycle of the agent.

Accordingly, in spite of the fact that an arithmetic processing content is simplified, the operation mode of the motion assisting device is able to be controlled so as to change appropriately following a change in the motion mode of the agent. Therefore, it is possible to assist the agent in motions by the operation mode appropriate in terms of maintaining the harmony with the periodic motion mode of the agent while reducing the arithmetic processing load.

### BRIEF DESCRIPTION OF THE DRAWINGS

FIG. 1 is a configuration schematic diagram of a motion assisting device according to one embodiment of the present invention;

FIG. 2 is a configuration schematic diagram of a controller of a motion assisting device according to a first embodiment of the present invention;

FIG. 3 is an explanatory diagram of a control method of the motion assisting device according to the first embodiment of the present invention;

FIG. 4 is an explanatory diagram on a method of setting a natural angular velocity;

FIG. 5 is a configuration schematic diagram of a controller of a motion assisting device according to a second embodiment of the present invention; and

FIG. 6 is an explanatory diagram of a control method of the motion assisting device according to the second embodiment of the present invention.

### DETAILED DESCRIPTION OF THE PREFERRED EMBODIMENTS

The preferred embodiments of a motion assisting device according to the present invention will be described in detail hereinafter with reference to the accompanying drawings.

Characters “R” and “L” will be used to distinguish between right and left of legs or the like in the following description. The characters, however, are omitted in the case where the there is no need to distinguish between right and left or where a vector having right and left components is represented. Moreover, signs “+” and “−” will be used to distinguish between the bending motion (forward motion) and the stretching motion (backward motion) of a leg (specifically, a thigh).

### First Embodiment

First, a motion assisting device according to a first embodiment of the present invention will be described.

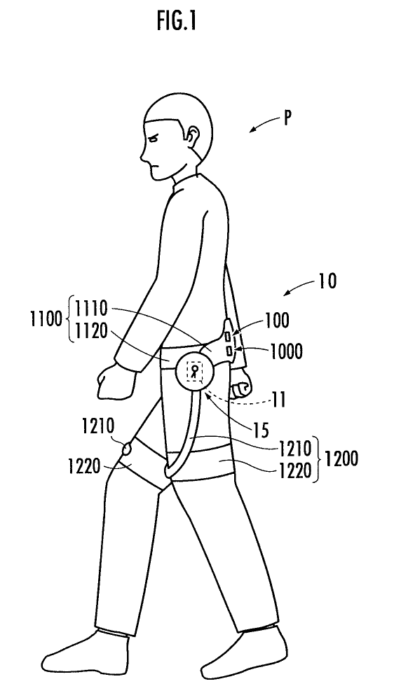

A motion assisting device 10 shown in FIG. 1 is a device for use in assisting an agent (a human) P in walking, having a first orthosis 1100 and a second orthosis 1200 attached to the waist (a first body part) and a thigh (a second body part) of the agent P, respectively. Moreover, the motion assisting device 10 includes a hip joint angle sensor 11, an actuator 15, a controller 100, and a battery 1000.

The first orthosis 1100 includes a first link member 1110 and a first orthosis 1120. The outside of the first link member 1110 is made of rigid material such as hard resin, and the inside of the first link member 1110 is made of soft material such as fibers. The first link member 1110 is put on the waist back side of the agent P. The actuator 15 is attached to the rigid member constituting the first link member 1110 so as to be disposed near the waist lateral side with the first link member 1110 put on the waist back side of the agent P.

The first orthosis 1120 has a mechanism for tightening the first link member 1110 to the waist back side of the agent P by being wound around the waist like a belt and a mechanism for adjusting the strength of the tightening force.

The second orthosis 1200 includes a second link member 1210 and a second orthosis 1220. The second link member 1210, which is made of rigid material, is directly connected to an output shaft of the actuator 15 or indirectly connected thereto via a speed reduction mechanism or the like. The second orthosis 1220, which is connected to the second link member 1210, includes a mechanism for tightening the second orthosis 1220 on the thigh by being wound around the thigh like a belt and a mechanism for adjusting the tightening force.

The material and shape of the first orthosis 1100 and the second orthosis 1200 or the position and the like of the actuator 15 are able to be arbitrarily changed within a range where the relative motion between the waist and the thighs of the agent P is able to be assisted.

The hip joint angle sensor 11 is composed of a rotary encoder disposed aside of the waist of the agent P and outputs a signal according to a hip joint angle. The actuator 15 is composed of an electric motor and appropriately includes one or both of a speed reducer and a compliance mechanism. The battery 1000 is housed in an appropriate place of the first orthosis 1100 and supplies electric power to the actuator 15, the controller 100, and the like. The controller 100 and the battery 1000 may be attached to or housed in the second orthosis 1200 or may be placed separately from the motion assisting device 10.

The controller 100 is composed of a computer (including a CPU, a ROM, a RAM, an I/O circuit, an A/D converter, and the like) housed in the first orthosis 1100 and software stored in a memory or a storage device (such as a HDD) of the computer. The controller 100 controls the operation or output torque τ of the actuator 15 by adjusting the electric power supplied from the battery 1000 to the actuator 15.

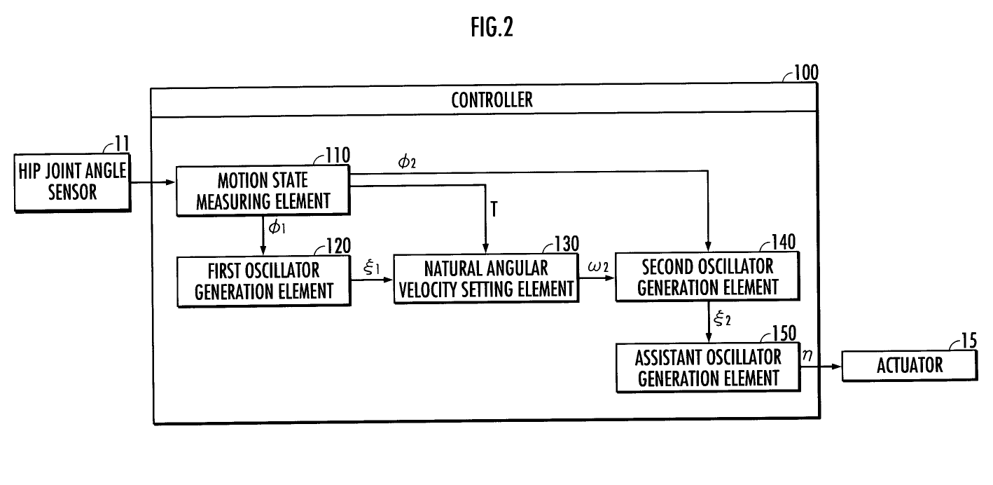

The controller 100 shown in FIG. 2 includes a motion state measuring element 110, a first oscillator generation element 120, a natural angular velocity setting element 130, a second oscillator generation element 140, and an assistant oscillator generation element 150. These elements may be each composed of hardware (such as a CPU) separately from each other, or a part or all of the elements may be composed of physically common hardware.

The motion state measuring element 110 measures a first motion oscillator φ₁ and a second motion oscillator φ₂ defined by a phase which periodically changes according to a periodic motion of the agent P. Measuring an oscillator means measuring the amplitude, phase, and angular velocity of the oscillator. The motion state measuring element 110 measures a motion index value ζ determined based on one or both of the motion scale and motion rhythm of the agent P on the basis of an output signal of an appropriate sensor.

The first oscillator generation element 120 generates a first oscillator ξ₁ as an output oscillating signal by inputting the first motion oscillator φ₁, which is measured by the motion state measuring element 110, as an input oscillating signal into a first model. Generating an oscillator means defining a time change mode of the amplitude and phase of the oscillator.

The natural angular velocity setting element 130 sets a second natural angular velocity ω₂ by selectively performing one of first setting processing and second setting processing, which is described later, depending on the situation.

The second oscillator generation element 140 generates a second oscillator ξ₂ as an output oscillating signal by inputting the second motion oscillator φ₂, which is measured by the motion state measuring element 110, as an input oscillating signal into a second model.

The assistant oscillator generation element 150 generates an assistant oscillator η, which determines a change pattern of the output torque τ of the actuator 15 of the motion assisting device 10, on the basis of the second oscillator ξ₂ generated by the second oscillator generation element 140.

The following describes a method of assisting the agent P in walking by the motion assisting device 10 according to the first embodiment of the present invention having the above configuration.

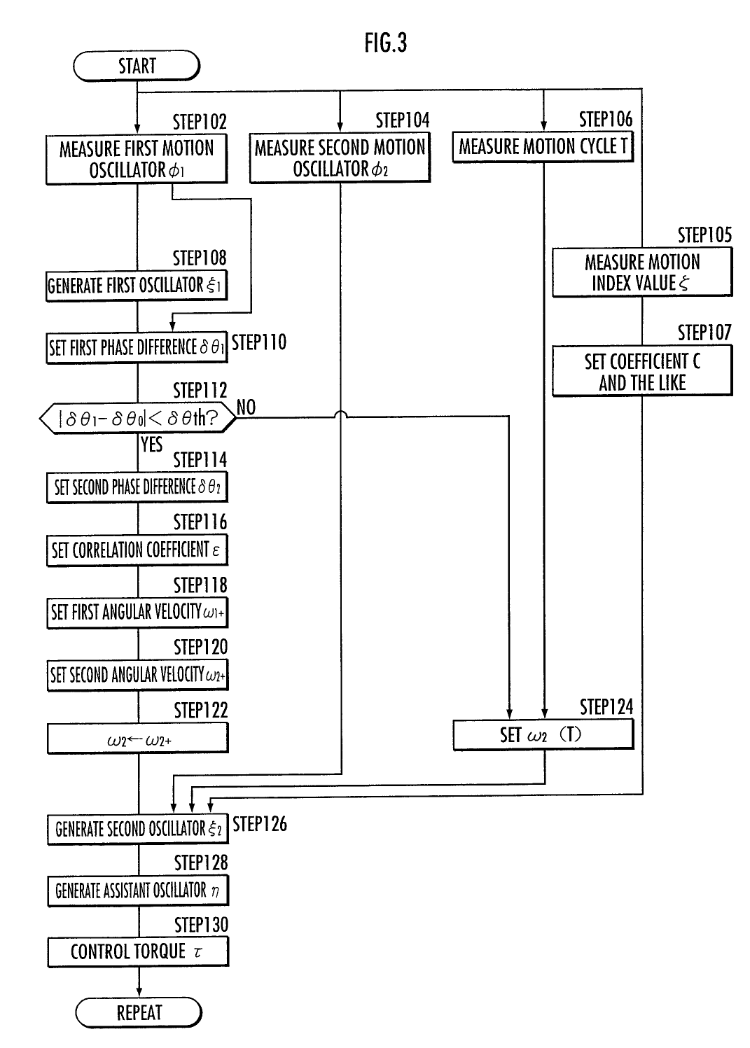

The motion state measuring element 110 measures the angular velocities of the right and left hip joints of the agent P as the first motion oscillator φ₁=(φ_{1L}, φ_{1R}) on the basis of an output of the hip joint angle sensor 11 (Step 102 of FIG. 3).

Further, the motion state measuring element 110 measures the angles of the right and left hip joints of the agent P as the second motion oscillator φ₂=(φ_{2L}, φ_{2R}) on the basis of the output of the hip joint angle sensor 11 (Step 104 of FIG. 3).

Moreover, an arbitrary variable, which periodically changes according to the periodic motion of the agent P, may be measured by using an appropriate sensor as each of the first motion oscillator φ₁ and the second motion oscillator φ₂.

For example, the motion state measuring element 110 may measure, as the motion oscillators, the change patterns of the angle and the angular velocity of an arbitrary joint such as a hip joint, a knee joint, an ankle joint, a shoulder joint, or an elbow joint and the change patterns of the position (the position in the anteroposterior direction or in the vertical direction or the like based on the center-of-gravity of the agent P), the velocity, and the acceleration of a thigh, a foot portion, an upper arm, a hand, and a waist.

Further, the motion state measuring element 110 may measure the change patterns of various parameters which change with a rhythm linking with a walking rhythm such as a sound generated when each of the right and left legs lands on the floor, respiratory sound, or an intentional sound production as one or both of the first motion oscillator φ₁ and the second motion oscillator φ₂.

Moreover, the motion state measuring element 110 may measure variables representing periodic motion states of the same body part such as the angle and the angular velocity of the same joint as the first motion oscillator φ₁ and the second motion oscillator φ₂, respectively, and may measure variables representing periodic motion states of different body parts such as the angular velocity of different joints as the first motion oscillator φ₁ and the second motion oscillator φ₂, respectively.

Further, the motion state measuring element 110 measures a motion index value ζ of the agent P (Step 105 of FIG. 3). Specifically, the walking ratio of the agent P is measured as the motion index value ζ. The walking ratio, which is the ratio of a step length representing the motion scale of the agent P to a walking rate (the number of steps per unit time) representing the motion rhythm of the agent P, is determined based on both of the motion scale and the motion rhythm.

The step length or walking rate may be measured as the motion index value ζ, instead of the walking ratio. The walking ratio, the step length, or the walking rate is able to be measured by a method disclosed in Japanese Patent Application Laid-Open No. 2007-275282 or Japanese Patent. Application Laid-Open No. 2007-275283.

Further, the motion state measuring element 110 measures a motion cycle T of the agent P (Step 106 of FIG. 3). Specifically, the motion state measuring element 110 measures the walking cycle of the agent P represented by the change cycle of an output signal from one of the right and left hip joint angle sensors 11 or an average of the change cycles of output signals from both of the right and left hip joint angle sensors 11, as the motion cycle T.

In addition, the motion state measuring element 110 may measure the motion cycles of different body parts, particularly, different body parts directly reflected on the amplitude of the motion oscillator φ, the phase, and the angular velocity separately from each other, such as measure the change cycles of the output signals from the hip joint angle sensors 11 as the motion cycles T_{L} and T_{R} of the right and left thighs, respectively. Moreover, the landing cycle may be measured as the motion cycle T on the basis of an output signal from a sensor which detects the landing of the agent P according to a method disclosed in Japanese Patent Application Laid-Open No. 2007-275282 or Japanese Patent Application Laid-Open No. 2007-275283 related to the invention of the related application by the present applicant.

Further, the first oscillator generation element 120 generates the first oscillator ξ₁ as an output oscillating signal by inputting the first motion oscillator φ₁ measured by the motion state measuring element 110 as an input oscillating signal into the first model (Step 108 of FIG. 3). The first model represents the correlation of a plurality of first elements such as the right and left legs and generates an output oscillating signal which changes at an angular velocity determined based on a first natural angular velocity ω₁=(ω_{1L}, ω_{1R}) by mutually entraining the input oscillating signal as described above. The first model is defined, for example, by a van del Pol equation represented by a relational expression (10).

The first oscillator generation element 120 may update the first model sequentially by adopting the latest second natural angular velocity ω₂, which is set by the natural angular velocity setting element 130, as the latest first natural angular velocity ω₁ and may generate a subsequent first oscillator ξ₁ as an output oscillating signal by inputting a subsequent first motion oscillator φ₁ as an input oscillating signal into the latest first model.

(d²φ_{1L}/dt²)=A(1−ξ_{1L}²)(dξ_{1L}/dt)−ω_{1L}²ξ_{1L}+g(ξ_{1L}−ξ_{1R})K₁φ_{1L},

(d²φ_{1R}/dt²)=A(1−ξ_{1R}²)(dξ_{1R}/dt)−ω_{1R}²ξ_{1R}+g(ξ_{1R}−ξ_{1L})K₁φ_{1R} (10)

where “A” is a positive coefficient set so that the first oscillator ξ₁ and its first-order time derivative (dξ₁/dt) forms a stable limit cycle on a ξ₁−(dξ₁/dt) plane, “g” is a first correlation coefficient for use in reflecting the correlation of different body parts such as the right and left legs of the agent P on the correlation of the right and left components of the first oscillator ξ₁ (the correlation of the output oscillating signals of a plurality of first elements), and “K₁” is a feedback coefficient according to the first motion oscillator φ₁.

The first oscillator ξ₁=(ξ_{1L}, ξ_{1R}) is generated according to the Runge-Kutta method. The angular velocities of the components ξ_{1L} and ξ_{1R} of the first oscillator ξ₁ represent hypothetic rhythms for assisting the motions of the right and left legs, respectively. Moreover, the first oscillator x has a property of periodically changing or oscillating with an autonomous angular velocity or rhythm determined based on the first natural angular velocity ω₁ while harmonizing with the rhythm of the first motion oscillator φ₁ which changes at substantially the same angular velocity or rhythm as an actual walking rhythm by the “mutual entrainment,” which is one of the properties of a van del Pol equation.

The first model may be represented by a van del Pol equation having a different form from the van del Pol equation represented by the relational expression (10), or the first model may be represented by any of all equations which generate an output oscillating signal periodically changing at an angular velocity determined based on the first natural angular velocity ω₁ by mutually entraining the input oscillating signal.

Moreover, the number of the first motion oscillators to be measured may be increased. The more the first motion oscillators φ₁ are input to the first model, the more the correlation terms increases in a nonlinear differential equation based on the generation of the first oscillator ξ₁ such as the van del Pol equation which defines the first model. The adjustment of the correlation coefficients, however, enables more accurate motion assistance in view of movements of various body parts of the agent P.

A phase difference between the periodic motion of the agent P and the periodic operation of the motion assisting device 10 is used to determine the motion mode of the agent P relative to the operation of the motion assisting device 10. For example, if the phase difference is positive, the agent P is able to make motions in such a manner as to lead the motion assisting device 10.

On the other hand, if the phase difference is negative, the agent P is able to make motions in such a manner as to be led by the motion assisting device 10. Therefore, if a phase difference (a first phase difference) δθ₁ of the first oscillator ξ₁ relative to the first motion oscillator φ₁ deviates from a desired phase difference δθ₀, the motion mode of the agent P is apt to be unstable. As a result, the motion rhythm of the agent P assisted in the relative motion of the waist and the thighs by the torque T which periodically changes at an angular velocity based on the assistant oscillator η is likely to deviate from the desired motion rhythm.

Therefore, from the viewpoint of matching the motion rhythm of the agent P with the desired motion rhythm while maintaining a mutual harmony between the first motion oscillator φ₁ and the first oscillator ξ₁, the natural angular velocity setting element 130 sets an appropriate second natural angular velocity ω₂ which determines the angular velocity of the second oscillator ξ₂. In other words, the appropriate second natural angular velocity ω₂ is set, from the viewpoint of achieving an appropriate phase difference between the assist rhythm of the motion assisting device 10 and the motion rhythm of the agent P, in order to match the motion rhythm of the agent P with the desired motion rhythm while harmonizing the assist rhythm of the motion assisting device 10 with the motion rhythm of the agent P.

More specifically, first, the phase difference between the first motion oscillator φ₁ and the first oscillator ξ₁ is set as a first phase difference δθ₁ (Step 110 of FIG. 3). For example, the first phase difference δθ₁ is calculated or set based on a time difference between the time satisfying φ₁=0 and (dφ₁/dt)>0 and the time satisfying ξ₁=0 and (dξ₁/dt)>0.

Subsequently, it is determined whether a deviation absolute value |δθ₁−-δθ₀| between the first phase difference δθ₁ and the desired phase difference δθ₀ is less than a threshold value δθₜₕ (Step 112 of FIG. 3).

If it is determined that the deviation absolute value |δθ₁−δθ₀| between the first phase difference δθ₁ and the desired phase difference δθ₀ is less than the threshold value δθₜₕ (YES in the Step 112 of FIG. 3), “first setting processing” described below is performed. In other words, first, the second phase difference δθ₂ is set (Step 114 of FIG. 3). More specifically, a phase difference between a first virtual oscillator ψ₁=(ψ_{1L}, ψ_{1R}) and the second virtual oscillator ψ₂=(ψ_{2L}, ψ_{2R}) defined in the virtual model represented by the relational expressions (21) and (22) is set as a second phase difference δθ₂ according to a relational expression (23). The first virtual oscillator ψ₁ represents the first motion oscillator φ₁ in a pseudo manner in the virtual model. The second virtual oscillator ψ₂ represents the assistant oscillator η in a pseudo manner in the virtual model.

dψ_{1L}/dt=ω_{1L}+ε_{L} sin(ψ_{2L}−ψ_{1L}), dψ_{1R}/dt=ω_{1R}+ε_{R} sin(ψ_{2R}−ψ_{1R}) (21)

dψ_{2L}/dt=ω_{2L}+ε_{L} sin(ψ_{1L}−ψ_{2L}), dψ_{2R}/dt=ω_{2R}+ε_{R} sin(ψ_{1R}−ψ_{2R}) (22)

δθ_{2L}=arc sin{(ω_{1+L}−ω_{2+L})/2ε_{L}}, δθ_{2R}=arc sin{(ω_{1+R}−ω_{2+R})/2ε_{R}} (23)

The components of ε=(ε_{L}, ε_{R}) are correlation coefficients representing the correlation between the components of the first virtual oscillator ψ₁ and the components of the second virtual oscillator ψ₂. ω₁₊=(ω_{1+L}, ω_{1+R}) represents an angular velocity of the components of the first virtual oscillator ψ₁. ω₂₊=(ω_{2+L}, ω_{2+R}) represents an angular velocity of the components of the second virtual oscillator ψ₂.

Subsequently, a correlation coefficient ε is set so as to minimize a deviation between the first phase difference δθ₁ and the second phase difference δθ₂ (Step 116 of FIG. 3). Specifically, a correlation coefficient ε(t) at each time tₖ when the first motion oscillator φ₁ reaches zero with respect to the right and left components is sequentially set according to the relational expression (24).

ε_{L}(tₖ₊₁)=ε_{L}(tₖ)−B_{L}{V_{1L}(tₖ₊₁)−V_{1L}(tₖ)}{ε_{L}(tₖ)−ε_{L}(tₖ₋₁)}

ε_{R}(tₖ₊₁)=ε_{R}(tₖ)−B_{R}{V_{1R}(tₖ₊₁)−V_{1R}(tₖ)}{ε_{R}(tₖ)−ε_{R}(tₖ₋₁)}

V_{1L}(tₖ₊₁)≡(1/2){δθ_{1L}(tₖ₊₁)−δθ_{2L}(tₖ)}²

V_{1R}(tₖ₊₁)≡(1/2){δθ_{1R}(tₖ₋₁)−δθ_{2R}(tₖ)}² (24)

The components of B=(B_{L}, B_{R}) are coefficients representing the stability of a potential V₁=(V_{1L}, V_{1R}) which approximates the components of the first phase difference δθ₁ to the right and left components of the second phase difference δθ₂.

Subsequently, the angular velocity of the first virtual oscillator ψ₁ is set as a first angular velocity ω₁, according to a relational expression (25) so as to minimize a deviation between the first phase difference δθ₁ and the second phase difference δθ₂ with respect to the components under the condition that the angular velocity ω₂₊ of the second virtual oscillator ψ₂ is constant on the basis of the correlation coefficient ε (Step 118 of FIG. 3).

ω_{1-L}(tₖ)=α_{L}∫dtq_{1L}(t), ω_{1+R}(tₖ)=−α_{R}∫dtq_{1R}(t)

q_{1L}(t)=(4ε_{L}²(t)−(ω_{1+L}(t)−ω_{2+L}(tₖ)))^{1/2}×sin(arc sin{(ω_{1+L}(t)−ω_{2-L}(tₖ₋₁))/2ε_{L}(tₖ)}−δθ_{2L}(tₖ))

q_{1R}(t)=(4ε_{R}²(t)−(ω_{1+R}(t)−ω_{2+R}(tₖ)))^{1/2}×sin(arc sin{(ω_{1+R}(t)−ω_{2-R}(tₖ₋₁))/2ε_{R}(tₖ)}−δθ_{2R}(tₖ)) (25)

The components of α=(α_{L}, α_{R}) are coefficients representing the stability of a system.

With the setting of the correlation coefficient ε and the first angular velocity ω₁₊, a virtual model is constructed so that the first virtual oscillator ψ₁ and the second virtual oscillator ψ₂ have a mutual harmony which exists between the first motion oscillator φₗ and the first oscillator ξ₁. In other words, the virtual model is constructed so that the first virtual oscillator ψ₁ representing the periodic motion of the agent P harmonizes with the second virtual oscillator ψ₂ representing the periodic operation of the motion assisting device 10 with the second phase difference δθ₂ during periodic changes.

Subsequently, the angular velocity of the second virtual oscillator ψ₂ is set as a second angular velocity ω₂₊ on the basis of the first angular velocity ω₁₊, with respect to the right and left components (Step 120 of FIG. 3). The second angular velocity ω₂₊=(ω_{2+L}, ω_{2+R}) is set according to a relational expression (26) so that the second phase difference δθ₂ approximates the desired phase difference δθ₀ with respect to the right and left components. Then, the second angular velocity ω₂₊ is set as the second natural angular velocity ω₂ (Step 124 of FIG. 3). The set of processes of the steps 114 to 122 correspond to the “first setting processing.”

ω_{2+L}(tₖ)=β_{L}∫dtq_{2L}(t), ω_{2+R}(tₖ)=β_{R}∫dtq_{2R}(t)

q_{2L}(t)=(4ε_{L}²(tₖ)−(ω_{1+L}(t)−ω_{2+L}(tₖ)))^{1/2}×sin(arc sin{(ω_{1+L}(tₖ)−ω_{2+L}(t))/2ε_{L}(tₖ)}−δθ₀)

q_{2R}(t)=(4ε_{R}²(tₖ)−(ω_{1+R}(t)−ω_{2+R}(tₖ)))^{1/2}×sin(arc sin{(ω_{1+R}(tₖ)−ω_{2+R}(t))/2ε_{R}(tₖ)}−δθ₀) (26)

The components of β=(β_{L}, β_{R}) are coefficients representing the stability of a system.

Thereby, while the mutual harmony, which exists between the first motion oscillator φ₁ and the first oscillator ξ₁, is maintained between the periodic motion of the agent P represented by the first virtual oscillator ψ₁ and the periodic operation of the motion assisting device 10 represented by the second virtual oscillator ψ₂, the second angular velocity ω_{2/} is set appropriately in terms of approximating the phase difference between the periodic motion and the periodic operation to the desired phase difference δθ₀.

On the other hand, if the deviation absolute value |δθ₁−δθ₀| of the first phase difference δθ₁ and the desired phase difference δθ₀ is determined to be equal to or greater than a threshold value δθₜₕ (No in the Step 112 of FIG. 3), the subsequently described “second setting processing” is performed, instead of the first setting processing. In other words, the second natural angular velocity ω₂ is set on the basis of the motion cycle T of the agent P measured by the motion state measuring element 110 according to a decreasing function with the motion cycle T as a variable (Step 124 of FIG. 3).

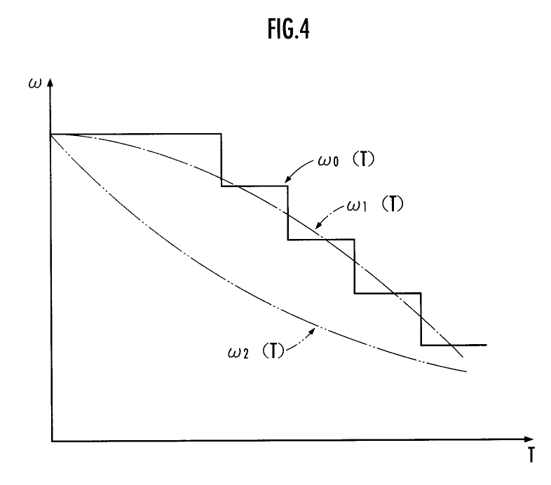

The decreasing function is stored in a storage device in an arithmetic algorithm or table format and is appropriately read from the storage device. The domain of the decreasing function may be either discrete or continuous. For example, the second natural angular velocity ω₂ is sequentially set on the basis of the motion cycle T at a certain time or for a period, according to a stepped or intermittent decreasing function ω₂₍₀₎(T) as indicated by a solid line in FIG. 4, a continuous decreasing function ω₂₍₁₎(T) having a negative second-order derivative value as indicated by a long dashed short dashed line, or a continuous decreasing function ω₂₍₂₎(T) having a positive second-order derivative value as indicated by a two-dot chain line. Further, the second natural angular velocity ω₂ may be set according to various functions such as a function which is a decreasing function in a part of the domain defined by the motion cycle T while being an increasing function in other parts of the domain.

In the case where the motion cycle T is measured with respect to each of different body parts, the second natural angular velocity ω₂ may be independently set for each motion cycle T. For example, if the motion cycles T_{L} and T_{R} of the respective thighs relative to the waist are measurec., the left natural angular velocity ω₁, may be set on the basis of the motion cycle T_{L} of the left thigh and the right second natural angular velocity ω_{2R} may be set on the basis of the motion cycle T_{R} of the right thigh.

In addition, if one second natural angular velocity changes, the other second natural angular velocity may be fluidly set so as to change in synchronization with or following the change, independently of the motion cycle T of the corresponding body part.

Moreover, the second oscillator generation element 140 generates a second oscillator ξ₂=(ξ_{2L+}, ξ_{2L-}, ξ_{2R+}, ξ_{2R-}) as an output oscillating signal by inputting the second motion oscillator φ₂ measured by the motion state measuring element 110 as an input oscillating signal into the second model (Step 126 in FIG. 3). The second model represents the correlation between a plurality of second elements such as neural elements, which control movements in the bending direction (forward) and movements in the stretching direction (backward) of the legs, and generates an output oscillating signal which changes at the angular velocity determined based on the second natural angular velocity ω₂ set by the natural angular velocity setting element 130 on the basis of the input oscillating signal as described above.

The second model is defined by, for example, the simultaneous differential equation (30):

τ_{1L+}(du_{L+}/dt)=C_{L+}ζ_{0L+}−u_{L+}+w_{L+/L-}ξ_{2L-}+w_{L+/R+}ξ_{2R+}−λ_{L}v_{L+}+f₁(ω_{2L})+f₂(ω_{2L})Kφ_{2L},

τ_{1L-}(du_{L-}/dt)=C_{L-}ζ_{0L-}−u_{L-}+w_{L-/L-}ξ_{2L+}+w_{L-/R-}ξ_{2R-}−λ_{L}v_{L-}+f₁(ω_{2L})+f₂(ω_{2L})Kφ_{2L},

τ_{1R+}(du_{R+}/dt)=C_{R-}ζ_{0R+}−u_{R+}+w_{R+/L+}ξ_{2L+}+w_{R+/R-}ξ_{2R+}−λ_{R}v_{R+}+f₁(ω_{2R})+f₂(ω_{2R})Kφ_{2R},

τ_{1R-}(du_{R-}/dt)=C_{R-}ζ_{0R-}−u_{R-}+w_{R-/L-}ξ_{2L-}+w_{R-/R+}ξ_{2R+}−λ_{R}v_{R-}+f₁(ω_{2R})+f₂(ω_{2R})Kφ_{2R},

τ₂ᵢ(dcᵢ/dt)=−v₂ᵢ+ξ₂ᵢ (i=L+, L−, R+, R−)

ξ₂ᵢ=E(uᵢ−uₜₕ)=0(uᵢ<uₜₕ) or uᵢ(uᵢ≧uₜₕ), or

ξ₂ᵢ=fs(uᵢ)=uᵢ/(1+exp(−uᵢ/D)) (30)

The simultaneous differential equation (30) includes a state variable uᵢ representing a behavior state (specified by an amplitude and a phase) each in the bending direction (forward) and in the stretching direction (backward) of each thigh and a self-control factor vᵢ for use in representing the adaptability of each behavior state. Moreover, the simultaneous differential equation (30) includes a coefficient cᵢ related to a desired value ζ₀ of the motion index value ζ.

As described later, it is possible to fluidly set a part or all of the values of a first time constant τ₁ᵢ, a second time constant τ₂ᵢ, the coefficient cᵢ related to the desired values ζ₀₁ of the motion variable ζᵢ, and the correlation coefficient w_{i/j}, and the like.

As described above, the number of motion oscillators φ to be measured may be increased. The more the motion oscillators φ are input to the second model, the more the correlation terms increases in the simultaneous differential equation. The adjustment of the correlation coefficients, however, provides an appropriate assist on the periodic motion of the agent P in terms of the correlation of the motion state of various body parts of the agent P.

The first time constant “τ₁ᵢ,” which is a time constant defining a variation character of the state variable uᵢ and is represented by a relational expression (31) by using a coefficient t(ω) having a co dependence and a constant γ=(γ_{L}, γ_{R}) , varies depending on the natural angular velocity ω.

τ_{1L+}=τ1L−=t(ω_{L})/ω_{L})−γ_{L}, τ_{1R+}=τ_{1R-}=(t(ω_{R})/ω_{R})−γ_{R} (31)

The second time constant “τ₂ᵢ” defines the variation character of the self-control factor vᵢ. A negative second correlation coefficient “w_{i/j}” represents the correlation between the state variables uᵢ and uⱼ representing movements in the bending direction and the stretching direction of the right and left legs of the agent P as a correlation between the components of the second oscillator ξ (the correlation of output oscillating signals of the plurality of second elements). Characters “λ_{L}” and “λ_{R}” are habituation functions. A character “K” is a feedback coefficient according to the motion oscillator φ.

The first function “f₁” is a linear function of the natural angular velocity ω defined by a relational expression (32) using a positive coefficient c. The second function “f₂” is a quadratic function of the natural angular velocity ω defined by a relational expression (33) using coefficients c₀, c₁, and c₂.

f₁(ω)≡cω (32)

f₂(ω)≡c₀ω+c₁ω+c₂ω² (33)

The second oscillator ξ₂ᵢ takes a value 0 if the value of the state variable uᵢ is less than a threshold value uₜₕ and takes the value uᵢ if the value of the state variable uᵢ is equal to or more than the threshold value uₜₕ. Alternatively, the second oscillator ξ₂ᵢ is defined by a sigmoid function fs (See the relational expression (30)).

Thereby, if the state variable u_{L+} representing the behavior toward the front side of the left thigh increases, the amplitude of the left/bending component ξ_{2L+} of the second oscillator ξ₂ exceeds the amplitude of the left/stretching component ξ_{2L-}. Moreover, if the state variable u_{R+} representing the behavior toward the front side of the right thigh increases, the amplitude of the right/bending component ξ_{2R+} of the second oscillator ξ₂ exceeds the amplitude of the right/stretching component ξ_{2R-}. Further, if the state variable u_{L-} representing the behavior toward the back side of the left thigh increases, the amplitude of the left/stretching component ξ_{2L-} of the second oscillator ξ₂ exceeds the amplitude of the left/bending component ξ_{2L+}. Moreover, if the state variable u_{R-} representing the behavior toward the back side of the right thigh increases, the amplitude of the right/stretching component ξ_{2R-} of the second oscillator ε₂ exceeds the amplitude of the right/bending component ξ_{2R+}. The movement toward the front side or the back side of the leg (thigh) is identified by, for example, the polarity of the hip joint angular velocity.

In the generation of the second oscillator ξ₂, the second oscillator generation element 140 fluidly sets the values of the coefficients or terms included in the simultaneous differential equation (30) so that the motion index value ζ of the agent P measured by the motion state measuring element 110 approximates its desired value ζ₀ (Step 107 of FIG. 3). Regarding values to be set, a part or all of the following values are fluidly set: the first time constant τ₁ᵢ (See the relational expression (31)), the second time constant τ₂=τ₂ᵢ, a coefficient cᵢ related to the desired value ζ₀ᵢ of the motion variable ζᵢ, a correlation coefficient w_{i/j}, a positive coefficient c defining the first function f₁ (See the relational expression (32)), and coefficients c₀ to c₂ (See the relational expression (33)) defining the second function f₂.

After the generation of the second oscillator ξ₂, the assistant oscillator generation element 150 sets the assistant oscillator η=(η_{L}, η_{R}) according to, for example, a relational expression (40) on the basis of the second oscillator ξ₂ (Step 114 of FIG. 3). In other words, the left component η_{L} of the assistant oscillator η is calculated as a sum of the product of the left/bending component ξ_{L+} and a coefficient χ_{L+} and the product of the left/stretching component ξ_{L-} and a coefficient −χ_{L-} of the second oscillator ξ. The right component η_{R} of the assistant oscillator η is calculated as a sum of the product of the right/bending component ξ_{R+} and a coefficient χ_{R}, and the product of the right/stretching component ξ_{R-} and a coefficient −χ_{R-} of the second oscillator ξ.

The assistant oscillator η may be generated so as to represent an elastic force of a virtual elastic element or D one or both of the elastic force and a damping force of a virtual damping element, as disclosed in Patent Documents 1 and 2.

η_{L}=χ_{L-}ξ_{L+}−χ_{L} ξ_{L-}, η_{R}=χ_{R+}ξ_{R+}−χ_{R-}ξ_{R-} (40)

Thereafter, the controller 100 adjusts the electric current I=(I_{L}, I_{R}) supplied to the right and left actuators 15 from the battery 1000 on the basis of the assistant oscillator η. The electric current I is represented by, for example, I(t)=G₁·η(t)(G₁: a proportionality factor) on the basis of the assistant oscillator η.

This adjusts a force which moves each thigh (the second body part) relative to the waist (the first body part) or a torque τ=(τ_{L}, τ_{R}) around the hip joint applied to the agent P from the motion assisting device 10 via the first orthosis 1100 and the second orthosis 1200 (Step 130 of FIG. 3).

The torque τ is represented by, for example, τ(t)=G₂·I(t)(G₂: a proportionality factor) on the basis of the electric current I. Thereafter, the set of processes are repeatedly performed. This moves the second orthosis 1200 relative to the first orthosis 1100, thereby assisting the periodic movement of each thigh (the second body part) relative to the waist (the first body part). After the agent P starts walking, the operation of the motion assisting device 10 may be controlled independently of the control method so that the thighs are moderately moved relative to the waist during a period until the walking of two or three steps is completed. The walking of the agent P may be performed on a treadmill.

According to the motion assisting device 10 of the first embodiment of the present invention which implements the above functions, the “first setting processing” is performed in principle (See steps 114 to 122 of FIG. 3). Thereby, as described above, while the mutual harmony, which exists between the first motion oscillator φ₁ and the first oscillator ξ₁, is maintained between the periodic motion of the agent P represented by the first virtual oscillator ψ₁ and the periodic operation of the motion assisting device 10 represented by the second virtual oscillator ψ₂, the second natural angular velocity ω₂ is set appropriately in terms of approximating the phase difference between the periodic motion and the periodic operation to the desired phase difference δθ₀.

Therefore, the output torque I, which is controlled based on the second oscillator ξ₂ periodically changing at an angular velocity determined based on the second natural angular velocity ω₂, periodically changes at an angular velocity determined based on the second natural angular velocity ω₂ (See Steps 126 to 130 of FIG. 3). Therefore, from the viewpoint of harmonizing the motion mode of the agent P with the operation mode of the motion assisting device 10, a torque τ which oscillates at an appropriate angular velocity is transmitted to the agent P, which consequently enables the agent P to be assisted appropriately in periodic walking.

On the other hand, the “second setting processing” is exceptionally performed in a situation where it is likely that the motion mode of the agent P gets out of harmony with the operation mode of the motion assisting device 10, more specifically a situation where the deviation absolute value between the first phase difference and the desired phase difference is equal to or greater than the threshold value (See the Step 124 of FIG. 3). The execution of the second setting processing sets the second natural angular velocity ω₂ on the basis of the motion cycle T of the agent P (See FIG. 4), by which the second oscillator ξ₂ oscillating at an appropriate angular velocity is able to be generated as an operation control basis of the motion assisting device 10 in terms of harmonizing the motion mode of the agent P with the motion assisting device 10.

Moreover, the second setting processing requires only a snorter arithmetic processing time for setting the second natural angular velocity ω₂ than the first setting processing based on the virtual model. Therefore, in a situation where it is likely that the motion mode of the agent P gets out of harmony with the operation mode of the motion assisting device 10 as described above, it is possible to quickly set the second natural angular velocity ω₂ which is appropriate in terms of maintaining the harmony. Therefore, it is possible to assist the agent P in making motions by the operation mode appropriate in terms of maintaining the harmony with the periodic motion mode of the agent P.

Moreover, in a situation where it is likely that the motion mode of the agent P gets out of harmony with the operation mode of the motion assisting device 10, it is possible to adjust the second natural angular velocity ω₂ according to the length of the motion cycle T of the agent P and consequently an operation cycle of the motion assisting device 10 appropriately in terms of maintaining the harmony between the motion mode of the agent P and the operation mode of the motion assisting device 10.

In other words, the periodic motion of the agent P is assisted by an output which changes at a relatively high angular velocity in a state of a short motion cycle T of the agent P (a state where the agent P is making a periodic motion with a relatively fast rhythm). Moreover, the periodic motion of the agent P is assisted by an output which changes at a relatively low angular velocity in a state of a long motion cycle T of the agent P (a state where the agent P is making a motion with a relatively slow rhythm). Accordingly, in spite of the fact that an arithmetic processing content is simplified, the operation mode of the motion assisting device 10 is able to be controlled so as to change appropriately following a change which occurs in the motion mode of the agent P. Therefore, it is possible to assist the agent P in motions by the operation mode appropriate in terms of maintaining the harmony with the periodic motion mode of the agent P while reducing the arithmetic processing load.

Moreover, if the two second natural angular velocities ω_{2L} and ω_{2R} are set independently of each other on the basis of different motion cycles and if one of the second natural angular velocities is fluidly set and thereby changes as described above, the other second natural angular velocity is able to be set in synchronization with or following the change. In other words, in the case where one second natural angular velocity is changed, the other second natural angular velocity is changed simultaneously or with a time lag of a specified time period determined according to the above following characteristic.

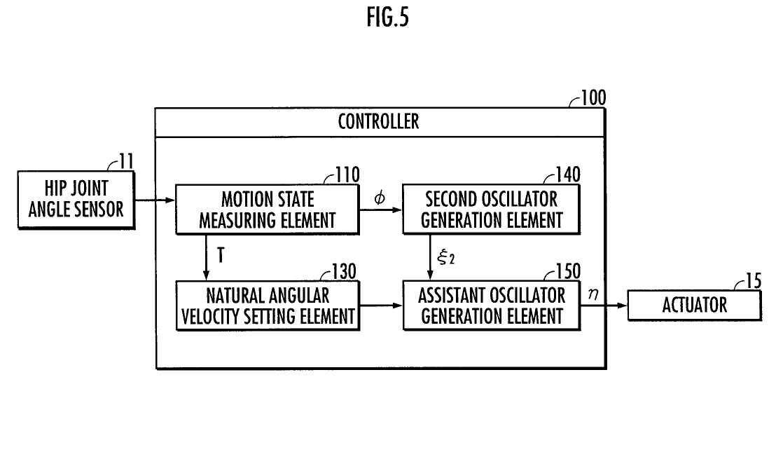

For example, when one second natural angular velocity changes from one value to another value, the other second natural angular velocity changes so as to agree with or approach another value simultaneously or almost simultaneously with the change. Thereafter, the amplitude, phase, and angular velocity of each torque τ of two actuators 15 are controlled based on the two second oscillators ξ_{2L} and ξ_{2R}, and the torque τ is transmitted to each of different body parts of the agent P, by which the periodic motion of the agent P is assisted (See FIG. 5).

Consequently, this enables a reduction in excessive divergence in the operation cycle or angular velocity of the motion assisting device 10 for assisting the agent P in making movements of each of two body parts. Therefore, it is possible to prevent a situation where the motion mode of the agent P excessively goes out of harmony with the operation mode of the motion assisting device 10 for any Length of time such that the agent P makes motions with maintaining the right and left motion symmetry while the motion assisting device 10 moves in such a way as to break the symmetry.

Further, in terms of approximating the motion index value ζ determined based on the motion scale and motion rhythm of the agent P to the desired value ζ₀, the operation scale (or the operation amplitude) and the operation rhythm (the operating angular velocity, or the operating angular velocity and phase) of the motion 2C assisting device 10 is able to be appropriately controlled (See the relational expressions (30) to (33), the Steps 105 and 107 of FIG. 3). The measurement of the motion index value ζ and the setting processing of coefficients or other values may be omitted.

### Second Embodiment

The following describes a motion assisting device according to a second embodiment of the present invention.

Since the motion assisting device 10 according to the second embodiment of the present invention is the same in most of the components as the motion assisting device 10 according to the first embodiment of the present invention, the same reference numerals are used for the same components and the description thereof is omitted.

The controller 100 according to the second embodiment shown in FIG. 5 is different from the controller 100 according to the first embodiment in that the first oscillator generation element 120 (See FIG. 2) is omitted. Moreover, when compared with each other, these embodiments are the same in that the natural angular velocity setting element 130 fluidly sets the natural angular velocity ω (corresponding to the second natural angular velocity ω₂ in the first embodiment) according to the decreasing function on the basis of the motion cycle T measured by the motion state measuring element 110, while the derails are different from each other as described later such that the virtual model is not used.

A method of assisting the agent P in walking by the motion assisting device 10 having the above configuration will be described below.

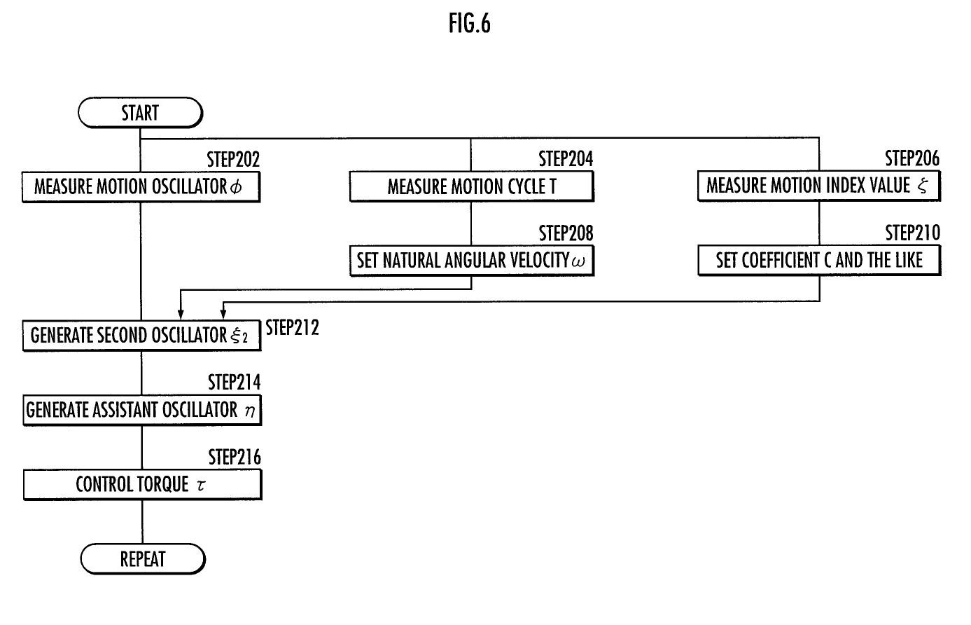

First, the motion state measuring element 110 measures the angles of the right and left hip joints of the agent P as a motion oscillator φ=(φ_{L}, φ_{R}) (corresponding to the second motion oscillator φ₂ in the first embodiment) on the basis of the outputs from the hip joint angle sensor 11 (Step 202 of FIG. 6).

Moreover, the motion state measuring element 110 measures the motion cycle T of the agent P (Step 204 of FIG. 6).

Further, the motion state measuring element 110 measures the motion index value ζ of the agent P (Step 206 of FIG. 6).

In addition, the second oscillator generation element 140 generates the second oscillator ξ₂=(ξ_{2L+}, ξ_{2L-}, ξ_{2R+}, ξ_{2R-}) as an output oscillating signal by inputting the motion oscillator φ measured by the motion state measuring element 110 as an input oscillating signal into the second model (See the simultaneous equation (30)) (Step 212 of FIG. 6).

As described later, also in the second embodiment, the natural angular velocity ω is able to be fluidly set in the same manner as in the first embodiment. Further, similarly as described later, a part or all of the following values are fluidly set: the first time constant τ₁ᵢ, the second time constant τ₂ᵢ, the coefficient cᵢ related to the desired value ζ₀ᵢ of the motion variable ζᵢ, the correlation coefficient w_{i/j}, and the like.

In generating the second oscillator ξ₂, the second oscillator generation element 140 sequentially or fluidly sets the natural angular velocity ω according to the decreasing function (See FIG. 4) with the motion cycle T of the agent P as a variable on the basis of the motion cycle T measured by the motion state measuring element 110 (Step 208 of FIG. 6).

Further, in generating the second oscillator ξ₂, the second oscillator generation element 140 fluidly sets the values of the coefficients or terms included in the simultaneous differential equation (30) so that the motion index value ζ of the agent P measured by the motion state measuring element 110 approximates the desired value ζ₀ (Step 210 of FIG. 6).

After the generation of the second oscillator ξ₂, the assistant oscillator generation element 150 sets an assistant oscillator η=(η_{L}, η_{R}) according to, for example, the relational expression (40) on the basis of the second oscillator ξ₂ (Step 214 of FIG. 6).

Then, the controller 100 adjusts the electric current I=(I_{L}, I_{R}) supplied to the right and left actuators 15 from the battery 1000 on the basis of assistant oscillator η. The electric current I is represented by, for example, I(t)=G₁·η(t)(G₁: a proportionality factor) on the basis of the assistant oscillator η. This adjusts a force which moves each thigh (the second body part) relative to the waist (the first body part) or the torque τ=(τ_{L}, τ_{R}) around the hip joint, which are applied from the motion assisting device 10 to the agent P via the first orthosis 1100 and the second orthosis 1200 (Step 216 of FIG. 6). The torque τ is represented by, for example, τ(t)=G₂·I(t)(G₂: a proportionality factor) on the basis of the electric current I. Thereafter, the set of processes are repeatedly performed.

This moves the second orthosis 1200 relative to the first orthosis 1100, thereby assisting the periodic movement of each thigh (the second body part) relative to the waist (the first body part). After the agent P starts walking, the operation of the motion assisting device 10 may be controlled independently of the control method so that the thighs are moderately moved relative to the waist during a period until the walking of two or three steps is completed. The walking of the agent P may be performed on a treadmill.

According to the motion assisting device 10 of the second embodiment of the present invention which implements the above functions, only a single model (the second model) is used for the arithmetic processing for generating the second oscillator ξ as the operation control basis of the actuator 15, and therefore it is possible to reduce the arithmetic processing load in comparison with the case where other models are used in addition to the single model (See the relational expression (31) and the Step 212 of FIG. 6). As the foregoing other models, there are the “first model” and the “virtual model” in the first embodiment.

Further, the natural angular velocity ω, which is reflected on the time rate of change of an angular velocity or phase of the second oscillator ξ which is an output oscillating signal from the model, is fluidly set according to a continuous or intermittent decreasing function on the basis of the motion cycle T of the agent P defined by the motion oscillator φ which is an input oscillating signal to this model (See the Step 208 of FIG. 6 and FIG. 4). Then, the second oscillator ξ is generated according to the model defined by the latest natural angular velocity ω, and the amplitude and phase of the torque T transmitted from the actuator 15 to the agent P are controlled on the basis of the second oscillator ξ (See the Steps 212 to 216 of FIG. 6).

As a result, the operation cycle of the motion assisting device 10 is able to be adjusted appropriately in terms of maintaining the harmony between the motion mode of the agent P and the operation mode of the motion assisting device 10 according to the length of the motion cycle T of the agent P. In other words, the periodic motion of the agent P is assisted by an output which changes at a relatively high angular velocity in a state of a short motion cycle T of the agent P (a state where the agent P is making a periodic motion with a relatively fast rhythm).

Moreover, the periodic motion of the agent P is assisted by an output which changes at a relatively low angular velocity in a state of a long motion cycle T of the agent P (a state where the agent P is making a motion with a relatively slow rhythm).

Accordingly, in spite of the fact that an arithmetic processing content is simplified, the operation mode of the motion assisting device 10 is able to be controlled so as to change appropriately following a change which occurs in the motion mode of the agent P. Therefore, it is possible to assist the agent P in motions by the operation mode appropriate in terms of maintaining the harmony with the periodic motion mode of the agent P while reducing the arithmetic processing load.

Further, in terms of approximating the motion index value ζ determined based on the motion scale and motion rhythm of the agent P to its desired value ζ₀, the operation scale (or the operation amplitude) and the operation rhythm (the operating angular velocity, or the operating angular velocity and phase) of the motion assisting device 10 is able to be appropriately controlled (See the relational expressions (30) to (33), the Steps 206 and 210 of FIG. 6).

Moreover, if the two natural angular velocities ω_{L} and ω_{R} are set independently of each other on the basis of different motion cycles and if one of the natural angular velocities is fluidly set and thereby changes as described above, t e other natural angular velocity is able to be set in synchronization with or following the change. In other words, in the case where one natural angular velocity is changed, the other natural angular velocity is changed simultaneously or with a time lag of a specified time period determined according to the above following characteristic.

For example, when one natural angular velocity changes from one value to another value, the other natural angular velocity changes so as to agree with or approach another value simultaneously or almost simultaneously with the change. Thereafter, the amplitude, phase, and angular velocity of each output or torque τ of the two actuators 15 are controlled based on the two second oscillators ξ_{2L} and ξ_{2R}, and the torque τ is transmitted to each of different body parts of the agent P, by which the periodic motion of the agent P is assisted.

This enables a reduction in excessive divergence in the operation cycle or angular velocity of the motion assisting device 10 for assisting the agent P in making movements of each of two body parts. Therefore, it is possible to prevent a situation where the motion mode of the agent P excessively goes out of harmony with the operation mode of the motion assisting device 10 for any length of time, such that the agent P makes motions with maintaining the right and left motion symmetry while the motion assisting device 10 moves so as to break the symmetry.

Although the motion of a human as the agent P is assisted in the above embodiments, the motion assisting device may assist walking or other motions of an animal other than a human such as a monkey, a dog, a horse, or a cow as an agent as another embodiment.

Although the motion assisting device 10 is adapted to assist the walking by assisting the movements of two symmetrical body parts, namely the right and left thighs (See FIG. 1) in the above embodiments, the motion assisting device 1C may be adapted to assist the movements of each of a plurality of asymmetrical body parts of the agent P such as a right upper arm and a left forearm, a right thigh and a right upper arm, or the like as another embodiment. Further, the motion assisting device 10 may be adapted to assist only the movement of one body part of the agent P such as one of the right and left thighs, one of the right and left upper arms, or the like. The shape, material, and number of orthoses may be changed so that the orthoses are able to be attached to various body parts of the agent P.

Although the motion index value ζ is measured and the coefficients or other values included in the simultaneous differential equation (30) are set so that the measured motion index value ζ agrees with its desired value ζ₀ in the above embodiments (See the Steps 105 and 107 of FIG. 3, the Steps 206 and 210 of FIG. 6), this processing may he omitted as another embodiment. In another embodiment, the natural angular velocity ω (the second natural angular velocity ω₂) is set according to the decreasing function (See FIG. 4) appropriately set or selected based on an experimental result, by which the first time constant τ₁ᵢ or the like having a dependence on the natural angular velocity ω is able to be changed appropriately in terms of matching the motion index value ζ such as a walking ratio of the agent P with its desired value ζ₀.

What is claimed is:

1. A motion assisting device comprising:
an orthosis attached to an agent;
an actuator connected to the orthosis; and
a controller which controls an amplitude and a phase of an output from the actuator, the motion assisting device assisting a periodic motion of the agent by transmitting the output from the actuator to the agent via the orthosis,
wherein the controller includes:
a motion state measuring element adapted to measure a motion oscillator defined by a phase periodically changing according to a periodic motion of the agent; and
a second oscillator generation element adapted to generate a second oscillator as a basis of the operation control of the actuator as an output oscillating signal by inputting the motion oscillator measured by the motion state measuring element as an input oscillating signal into a second model, which is defined by a simultaneous differential equation with a plurality of state variables representing motion states of the agent and generates on the basis of the input oscillating signal the output oscillating signal changing at an angular velocity determined based on a second natural angular velocity,
wherein the motion state measuring element is adapted to measure a motion cycle of the agent, and
wherein the controller further includes a natural angular velocity setting element adapted to set the second natural angular velocity fluidly on the basis of the motion cycle of the agent measured by the motion state measuring element.

2. The motion assisting device according to claim 1, wherein:
the controller further includes a first oscillator generation element which generates a first oscillator as the output oscillating signal by inputting a first motion oscillator, which is the motion oscillator measured by the motion state measuring element, as the input oscillating signal into a first model for generating the output oscillating signal which changes at an angular velocity determined based on a first natural angular velocity by mutually entraining the input oscillating signal; and
the natural angular velocity setting element performs first setting processing in which an angular velocity of a second virtual oscillator is set as the second natural angular velocity so that a second phase difference approximates a desired phase difference according to a virtual model representing a first virtual oscillator and the second virtual oscillator which periodically change with the second phase difference while interacting with each other on the basis of a first phase difference which is a phase difference between the first motion oscillator measured by the motion state measuring element and the first oscillator generated by the first oscillator generation element, while performing second setting processing in which the second natural angular velocity is set on the basis of the motion cycle of the agent measured by the motion state measuring element with a requirement that an absolute value of a deviation between the first phase difference and the desired phase difference is equal to or greater than a threshold value, instead of the first setting processing.

3. The motion assisting device according to claim 2, wherein the natural angular velocity setting element fluidly sets the second natural angular velocity according to a continuous or intermittent decreasing function with the motion cycle of the agent as a variable.

4. The motion assisting device according to claim wherein:
outputs from two actuators are transmitted to two different body parts of the agent via two orthoses attached to the two body parts, respectively;
the second oscillator generation element generates two second oscillators which change at angular velocities determined based on the two second natural angular velocities, respectively, as a control basis of the two actuators; and
the natural angular velocity setting element fluidly sets the two second natural angular velocities so that, upon a change in one of the second natural angular velocities, the other second natural angular velocity changes in synchronization with or following the change in performing the second setting processing.

5. The motion assisting device according to claim 4, wherein outputs from the two actuators are transmitted to symmetrical body parts which are the two body parts of the agent, respectively.

6. The motion assisting device according to claim 2, wherein:
the motion state measuring element measures a motion index value determined based on one or both of the motion scale and motion rhythm of the agent; and
the second oscillator generation element fluidly sets values of coefficients or terms included in the simultaneous differential equation which defines the second model so that the motion index value measured by the motion state measuring element approximates a desired value thereof.

7. The motion assisting device according to claim 1, wherein the controller includes only the second oscillator generation element as a component having a model.

8. The motion assisting device according to claim 7, wherein the natural angular velocity setting element fluidly sets the second natural angular velocity according to The continuous or intermittent decreasing function with the motion cycle of the agent as a variable.

9. The motion assisting device according to claim 7, wherein:
outputs from the two actuators are transmitted to the two different body parts of the agent via the two orthoses attached to the two body parts, respectively;
the second oscillator generation element generates two second oscillators which change at angular velocities determined based on the two second natural angular velocities, respectively, as a control basis of the two actuators; and
the natural angular velocity setting element fluidly sets the two natural angular velocities according to the decreasing function so that, upon a change in one of the natural angular velocities, the other natural angular velocity changes in synchronization with or following the change.

10. The motion assisting device according to claim 9, wherein outputs from the two actuators are transmitted to symmetrical body parts which are the two body parts of the agent, respectively.

11. The motion assisting device according to claim 7, wherein:
the motion state measuring element measures a motion index value determined based on one or both of the motion scale and motion rhythm of the agent; and
the second oscillator generation element fluidly sets values of coefficients or terms included in the simultaneous differential equation which defines the second model so that the motion index value measured by the motion state measuring element approximates a desired value thereof.

12. A motion assisting method of assisting an agent in making a periodic motion by transmitting an output from an actuator to the agent via an orthosis attached to the agent, comprising the steps of:
measuring a motion oscillator defined by a phase which periodically changes according to a periodic motion of the agent;
generating a second oscillator as a basis of the operation control of the actuator as an output oscillating signal by inputting the motion oscillator measured by the motion state measuring element as an input oscillating signal into a second model, which is defined by a simultaneous differential equation with a plurality of state variables representing motion states of the agent and generates the output oscillating signal changing at an angular velocity determined based on a second natural angular velocity on the basis of the input oscillating signal;
measuring a motion cycle of the agent; and
fluidly setting the second natural angular velocity on the basis of the motion cycle of the agent.
